(19) United States
(12) Patent Application Publication
(10) Pub. No.: US 2026/0359273 A1
(43) Pub. Date: Nov. 12, 2026

(54) SYSTEM FOR COGNITIVE, SELF-VERIFYING ANOMALY DETECTION THROUGH REINFORCED VARIATIONAL LEARNING AND A METHOD THEREOF

(71) Applicant: RAPTORXAI PRIVATE LIMITED, Tellapur (IN)

(72) Inventors: Pratyusha Vemuri Venkata, Tellapur (IN); Zhongyuan Wang, Hangzhou (CN)

(21) Appl. No.: 19/669,910

(22) Filed: May 6, 2026

(30) Foreign Application Priority Data
May 10, 2025 (IN) 202541045354

(51) Int. Cl. G06F 16/215; G06N 3/0455

(52) U.S. Cl. CPC G06F 16/215; G06N 3/0455

(57) ABSTRACT

The present invention relates to a system and method for cognitive self-verifying anomaly identification in heterogeneous data environments. The system comprises a data gathering module configured to acquire structured and unstructured data from multiple sources, a preprocessing module to cleanse, normalize, and transform the data, and a reinforced variational learning module that includes a feature extraction sub-module, an anomaly detection sub-module, a reinforcement learning engine, and a variational inference model. The anomaly detection process dynamically optimizes its parameters based on real-time feedback to enhance detection accuracy. A verification module cross-references detected anomalies with historical data and contextual parameters to validate their authenticity, while a feedback module updates detection parameters to improve ongoing performance. An output interface provides real-time alerts and reports of verified anomalies.

### FIELD OF THE INVENTION

The present invention relates to the field of data analytics and anomaly detection systems. More particularly, the present invention relates to a cognitive, self-verifying system and method for identifying anomalies within structured and unstructured data collected from heterogeneous sources, employing reinforced learning and variational inference techniques to enhance accuracy, reliability, and real-time responsiveness.

### BACKGROUND OF THE INVENTION

In recent years, the exponential growth of data generated across various sectors, including finance, healthcare, cybersecurity, and industrial operations, has significantly heightened the demand for advanced anomaly detection systems. These datasets, often characterized by their scale, heterogeneity, and complexity, have outpaced the capabilities of traditional detection methods. Conventional anomaly detection techniques typically rely on static thresholds, rule-based systems, or basic statistical models. While these approaches were effective in simpler, more controlled environments, they often struggle to manage the dynamic and multifaceted nature of modern data. The inability to process large-scale, heterogeneous datasets means that traditional methods often fail to detect nuanced, evolving patterns in the data, resulting in higher rates of false positives and false negatives. This compromises the reliability and efficiency of anomaly detection processes, particularly in mission-critical applications.

Moreover, existing systems frequently lack robust verification mechanisms to confirm the accuracy of detected anomalies. Verification is particularly important in domains where even a single false detection or missed anomaly can have significant consequences such as in the case of cybersecurity breaches, financial fraud detection, or patient monitoring in healthcare. Without mechanisms to validate detected anomalies, decisions based on such detections may lead to suboptimal outcomes, risking both operational inefficiencies and, in some cases, financial or safety risks. Furthermore, the lack of dynamic adaptability in current systems means they are unable to adjust to evolving data patterns over time, reducing their effectiveness in long-term use.

While machine learning-based approaches have improved anomaly detection by enabling the detection of complex, non-linear relationships in the data, many of these systems still fall short of integrating real-time feedback loops. Without these adaptive capabilities, machine learning models can become outdated or suboptimal, leading to a decline in their ability to detect anomalies accurately. To address these challenges, there exists a need for an advanced anomaly detection system that is capable of overcoming the drawbacks of the prior arts.

### OBJECTS AND SUMMARY OF THE INVENTION

In view of the foregoing disadvantages inherent in the prior art, the general purpose of the present disclosure is to provide a cognitive self-verifying anomaly identification system and a method thereof, to include all advantages of the prior art, and to overcome the drawbacks inherent in the prior art.

Some of the objects of the present disclosure, which at least one embodiment herein satisfies, are as follows:

An object of the present disclosure is to ameliorate one or more problems of the prior art or to at least provide a useful alternative. An object of the present disclosure is to provide a cognitive self-verifying anomaly identification system.

Another object of the present disclosure is to provide a method for a cognitive self-verifying anomaly identification.

Another object of the present disclosure is to provide a cognitive self-verifying anomaly identification system that efficiently detects and validates anomalies in both structured and unstructured data sourced from heterogeneous data environments.

Another object of the present disclosure is to develop a system capable of real-time data gathering, ensuring continuous monitoring and timely detection of anomalies across diverse data streams and repositories.

Another object of the present disclosure is to establish a feedback loop that continuously refines anomaly detection parameters based on verification outcomes, ensuring that the system evolves and improves over time.

Another object of the present disclosure is to implement a reinforced variational learning framework that extracts meaningful features from data and dynamically adjusts anomaly detection parameters through reinforcement learning for improved detection accuracy and adaptability.

Other objects and advantages of the present disclosure will be more apparent from the following description, which is not intended to limit the scope of the present disclosure.

The cognitive self-verifying anomaly identification system of the present disclosure is designed to intelligently detect and validate anomalies within structured and unstructured data from diverse sources. The system features a data gathering module that captures real-time and batch data from multiple heterogeneous inputs, followed by a preprocessing module that ensures data integrity through cleansing, normalization, deduplication, noise reduction, and transformation.

The system comprises a reinforced variational learning module, which includes a feature extraction sub-module to distill meaningful patterns and a sophisticated anomaly detection sub-module. This detection unit utilizes a variety of parameters such as statistical thresholds, reconstruction error limits, clustering metrics, and temporal windows to flag potential anomalies. A reinforcement learning engine dynamically refines these parameters based on performance feedback, enhancing detection accuracy over time. Complementing this is a variational inference model, which provides probabilistic assessments of the identified anomalies, ensuring robust differentiation between true and false anomalies.

For further reliability, a verification module cross-validates anomalies using historical data and contextual rules, combining rule-based logic and machine learning techniques for enhanced accuracy. The system's feedback module continuously loops validation outcomes back into the detection model, enabling adaptive learning and sustained performance improvements. An output interface delivers real-time alerts and comprehensive reports, keeping stakeholders informed of verified anomalies as they arise.

The present invention also encompasses a method that mirrors this architecture-systematically acquiring, preprocessing, analyzing, validating, and reporting anomalies while dynamically refining detection criteria. This ensures high precision and adaptability in environments where data is vast, varied, and continuously evolving.

### BRIEF DESCRIPTION OF THE DRAWINGS

The foregoing summary, as well as the following detailed description of various embodiments, is better understood when read in conjunction with the drawings provided herein. For the purposes of illustration, there are shown in the drawings exemplary embodiments; however, the presently disclosed subject matter is not limited to the specific methods and instrumentalities disclosed.

FIG. 1 illustrates a flow chart depicting working of a system for cognitive self-verifying anomaly identification;

FIG. 2 illustrates a block diagram depicting interconnection of different components of the system as disclosed in the present disclosure;

FIG. 3 illustrates a flow chart depicting working of Gradient-based Reinforcement Learning Policy Optimization training of the system as disclosed in the present disclosure; and

FIG. 4 illustrates a flow chart depicting architecture of reinforcement learning variational autoencoder;

Like reference numerals refer to like parts throughout the description of several views of the drawing.

### DETAILED DESCRIPTION OF THE INVENTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

Furthermore, the term “module”, as used herein, refers to logic embodied in hardware or firmware, or to a collection of software instructions, written in a programming language, such as, Java, C, C++, python, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDS, DVDS, BLU-RAY, flash memory, and hard disk drives.

The present invention relates to a system and method for cognitive self-verifying anomaly identification, that integrates reinforced variational learning with adaptive feedback mechanisms to perform anomaly detection, validation, and refinement within structured and unstructured data environments.

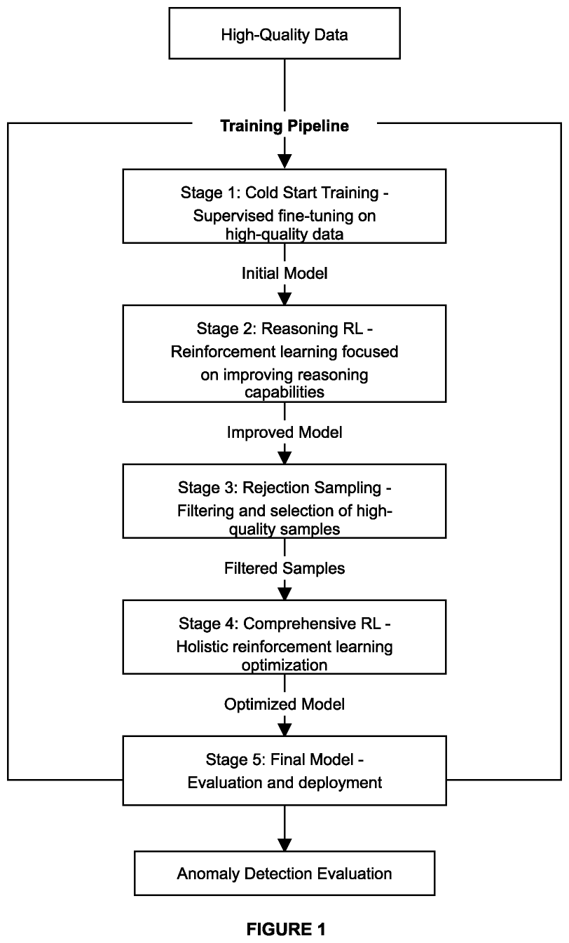

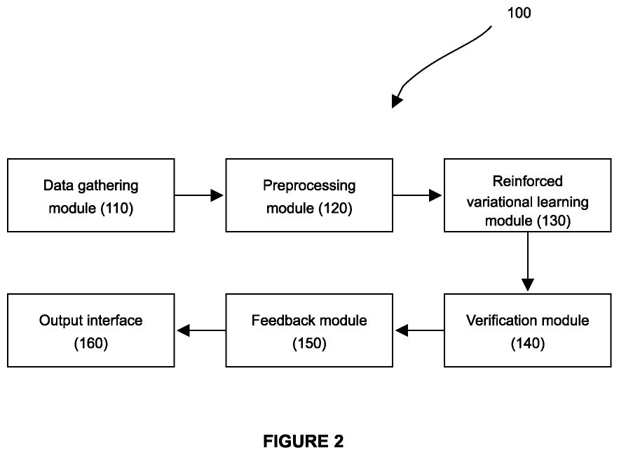

In an embodiment of the present disclosure, the system comprises a data gathering module (110) configured to acquire structured and unstructured data from a plurality of heterogeneous sources. These sources may include, but are not limited to, real-time sensors, Internet of Things (IoT) devices, network traffic logs, transactional databases, and archival storage systems. The data gathering module (110) ensures high-fidelity and lossless acquisition of data, employing protocols to maintain data integrity and timestamp synchronization across distributed nodes (as illustrated in the FIGS. 1 and 2).

The data acquired by the data gathering module (110) is routed to a preprocessing module (120), which is operatively coupled to the data gathering module (110). The preprocessing module (120) cleanses, normalizes, and transforms raw data into an analytically suitable format. The preprocessing module (120) may include a deduplication unit to eliminate redundant entries, a noise reduction unit to filter out irrelevant data points, and a standardization engine to convert heterogeneous data formats into a uniform schema. The preprocessing module (120) also addresses missing values, outlier correction, and ensures that the data conforms to the analytical models' input requirements.

The preprocessing module (120) undertakes data deduplication, where the preprocessing module (120) identifies and eliminates redundant entries. This step involves comparing data records using unique identifiers or hash-based fingerprinting techniques to ensure that duplicate data points common when multiple sources overlap are removed efficiently. In cases where exact duplicates are not present but near-duplicates exist due to slight variations or input inconsistencies, advanced record linkage algorithms and fuzzy matching techniques are applied. This ensures that only unique and relevant data records are passed forward for further processing.

Following deduplication, the module engages in noise reduction, aiming to filter out irrelevant, corrupted, or erroneous data points. Noise, particularly in unstructured data such as text, images, or sensor feeds, can significantly impair model performance. To address this, the preprocessing module (120) employs statistical outlier detection methods, such as standard deviation filters and interquartile range (IQR) checks for numerical data. For unstructured data, techniques like stop-word removal for text and denoising filters such as Gaussian blur or median filters for image data—are integrated. In sophisticated implementations, the module may utilize machine learning-based classifiers or deep neural networks to identify and remove noise patterns that are not detectable by traditional statistical methods.

Further, the preprocessing module (120) performs data standardization, where the preprocessing module (120) ensures that all data conforms to a uniform schema compatible with the downstream analytical processes. Numerical data undergoes normalization, scaling values into a specified range, typically between 0 and 1, or standardization, transforming data to have a mean of zero and a standard deviation of one. Categorical data is processed using encoding techniques, such as one-hot encoding or label encoding, converting textual categories into machine-readable numeric formats. In cases involving temporal or sequential data, timestamps are standardized to a uniform format, accounting for time zone differences, while missing temporal entries are interpolated or imputed using contextually appropriate methods.

The preprocessing module (120) is also responsible for handling missing data and outlier correction. Missing data points are addressed through imputation techniques, which may range from simple methods such as mean, median, or mode substitution, to more advanced predictive imputation using regression models or k-nearest neighbor approaches. Outliers that might skew the analysis are detected through robust statistical checks and are either corrected, if possible, or flagged and isolated to prevent adverse effects on model performance. For unstructured data, the module performs syntactic and semantic checks to fill in gaps or correct anomalies in textual and visual inputs.

In another embodiment of the present disclosure, a Reinforced variational learning module (130) is coupled with the preprocessing module (120). Once the data has been cleaned, standardized, and transformed, it is fed into the Reinforced variational learning module (130) for deep analysis and anomaly identification. The Reinforced variational learning module (130) includes a feature extraction sub-module, that is specifically configured to derive both latent and explicit features from the preprocessed data. This sub-module plays a pivotal role in distilling high-dimensional data into a more compact and meaningful representation that the subsequent stages can efficiently analyze.

The variational learning module is further enhanced with multiple reasoning paths that process the latent vector derived from latent space parameters. Each reasoning path consists of a distinct sequence of computational layers or logic-based transformations that interpret and refine the latent representation. During a forward pass, the system (100) explicitly executes reasoning steps across these parallel pathways, enabling diverse perspectives on the encoded features. The intermediate reasoning states produced by each path are captured and aggregated to inform the final reconstruction. This multi-path architecture facilitates deeper reasoning and improves the model's ability to handle complex patterns in the input data.

The verification module (140) not only detects anomalies but also produces a quantitative confidence score by evaluating the reconstruction quality. This score reflects how well the output aligns with expected patterns and guides further refinement steps when the confidence falls below a defined threshold.

The feature extraction process incorporates a variety of sophisticated techniques. For instance, dimensionality reduction methods, such as Principal Component Analysis (PCA) and t-distributed Stochastic Neighbor Embedding (t-SNE), are applied to simplify data by retaining only the most informative components while eliminating noise and redundancy. Clustering algorithms, such as k-means or DBSCAN, are utilized to identify natural groupings or clusters within the data, which is essential in understanding underlying structures and detecting deviations. Furthermore, deep representation learning leveraging neural networks like autoencoders or convolutional neural networks (CNNs) is integrated to uncover complex, non-linear patterns that traditional statistical methods might overlook. This multi-faceted feature extraction ensures that the model captures both obvious and subtle indicators of potential anomalies.

Once these feature sets are derived, they are passed to the anomaly detection sub-module, which is responsible for identifying data points that deviate from the learned norms and patterns. This sub-module applies a meticulously defined set of anomaly detection parameters to perform its task. These parameters include threshold values that define acceptable ranges for specific metrics; reconstruction errors generated by autoencoder models to highlight deviations; clustering variances that measure how far a data point is from its cluster centroid; time-series windowing strategies to track anomalies over temporal sequences; and weighted feature importance metrics that prioritize certain features over others based on their relevance to anomaly detection. By employing this multi-parametric strategy, the anomaly detection sub-module can capture a wide variety of anomaly types whether they are point anomalies, contextual anomalies, or collective anomalies.

To ensure the system (100) remains adaptive and optimally tuned, a reinforcement learning engine is integrated within the Reinforced variational learning module (130). This engine dynamically optimizes the anomaly detection parameters by continuously evaluating the performance of the anomaly detection sub-module. It utilizes a reward function, which is calibrated to enhance overall detection accuracy while minimizing false positives (incorrectly identifying normal data as anomalous) and false negatives (failing to identify true anomalies). Through iterative learning cycles, the reinforcement learning engine adjusts parameters in real time, allowing the system (100) to evolve in tandem with changing data landscapes and newly emerging anomaly patterns. This capability is critical in environments where data characteristics can shift frequently, such as financial markets, cybersecurity contexts, or industrial IoT networks.

The reinforcement learning engine is further configured to implement gradient-based reinforcement learning policy optimization. Specifically, it employs techniques such as policy gradient methods, where the gradient of the expected reward with respect to the policy parameters is computed to adjust the decision-making process. This allows the system (100) to fine-tune its anomaly detection parameters by directly optimizing the reward signal, which is defined by metrics such as detection accuracy, false positives, and false negatives. The gradient-based optimization framework ensures efficient convergence and adaptability, enabling the system (100) to respond dynamically to changes in data patterns. The reinforcement learning engine may leverage advanced optimization protocols such as REINFORCE, actor-critic methods, or proximal policy optimization (PPO) to iteratively update the policy network, thereby refining the anomaly detection performance over time.

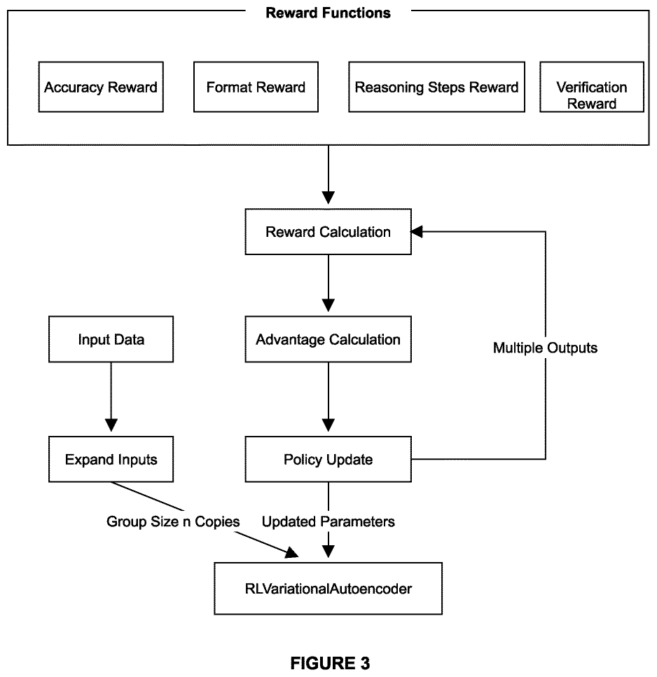

As illustrated in FIG. 3, the gradient-based reinforcement learning policy optimization (GRPO) approach operates by expanding each input into a group of size n, generating multiple candidate outputs. For each output, the system (100) computes reward values based on predefined reward functions, such as reconstruction accuracy, format compliance, reasoning quality, and verification confidence. The optimization leverages advantage calculation to assess performance improvements and applies clipped probability ratios similar to proximal policy optimization (PPO) to ensure stable policy updates while preventing excessive deviations from prior model behavior. This process iteratively refines the model to maximize output quality.

The training of the neural network follows a multi-stage approach designed for robust performance. Initially, the system (100) undergoes cold start training using supervised learning, allowing it to learn basic patterns and mappings from input to output. This is followed by a reasoning-oriented reinforcement learning phase, where the model focuses on improving intermediate reasoning steps and reconstruction quality through reward-based optimization. A rejection sampling mechanism is applied to filter out low-quality generated samples, ensuring only high-confidence outputs contribute to training. Finally, a phase of comprehensive reinforcement learning optimization consolidates the learning by fine-tuning model parameters across all modules and pathways, resulting in a highly reliable and precise system (100).

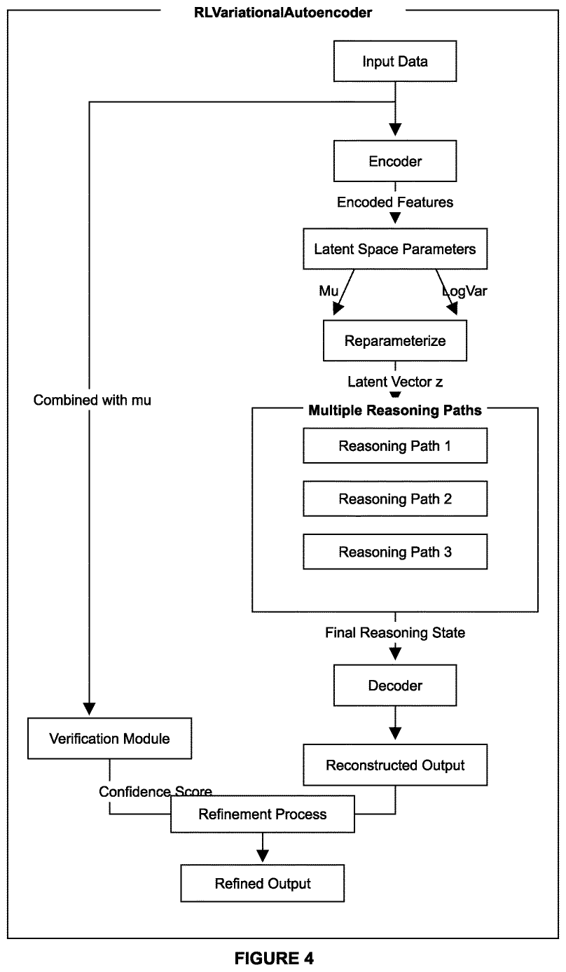

Further enhancing the analytical robustness, the module incorporates a variational inference model. This model does not merely flag anomalies in a binary fashion but assigns probabilistic scores to each detected anomaly. These scores represent the likelihood that a flagged data point is indeed a true anomaly, adding a crucial layer of probabilistic reasoning to the decision-making process. For instance, an anomaly with a high probabilistic score is more likely to represent a genuine irregularity, while those with lower scores might be borderline cases that warrant closer scrutiny or additional validation. The use of variational inference often implemented via a reinforcement learning variational autoencoder (RLVAE) (as illustrated in FIG. 4) enables the system (100) to handle uncertainty in a principled manner, distinguishing between anomalies that are confidently anomalous and those that may arise due to borderline or noisy data characteristics.

Once the preliminary anomaly identification is complete, the flagged data points are passed to a verification module (140). The verification module (140) is communicatively coupled to the Reinforced variational learning module (130). The primary role of the verification module (140) is to provide a multi-layered validation process that confirms whether detected anomalies are authentic and actionable. This module undertakes a rigorous cross-referencing process, where each detected anomaly is checked against historical datasets to identify if similar patterns have occurred previously and whether they were classified as true anomalies or false alarms. Additionally, the module reviews contextual metadata such as timestamps, location data, or system state information to place anomalies within a broader situational framework, which can provide critical insights into whether a deviation is genuinely anomalous or contextually normal.

To enhance the thoroughness and accuracy of validation, the verification module (140) integrates both rule-based engines and machine learning-based contextual evaluators. The rule-based engine applies predefined business rules, compliance standards, or expert-defined thresholds to quickly validate straightforward cases. In contrast, the machine learning-based evaluator, which may use supervised learning or ensemble methods, analyzes more complex scenarios that cannot be easily addressed through static rules. By combining these two approaches, the module ensures that validation is both rigorous and flexible, capable of handling routine cases efficiently while also delving deep into ambiguous or complex anomalies.

Upon completing the validation, the module determines the status of each anomaly. Those that successfully pass all verification checks are flagged as verified anomalies and are logged for further action or reporting. Conversely, anomalies that fail the verification criteria are either discarded if they are confirmed to be false positives or flagged for manual review, particularly in cases where the system is uncertain or where the potential impact of a false negative is high.

Through the integration of these meticulously engineered components—the feature extraction sub-module, anomaly detection sub-module, reinforcement learning engine, variational inference model, and verification module (140)—the system (100) provides a comprehensive, adaptive, and highly accurate solution for cognitive self-verifying anomaly identification. Each module is designed to contribute to a pipeline that not only detects anomalies effectively but also validates them rigorously, ensuring that stakeholders receive alerts and reports that are both timely and reliable.

Furthermore, a feedback module (150) is operatively linked to both the verification model (140) and the reinforced variational learning module (130). The feedback module (150) captures the outcomes of the verification process and transmits performance metrics back to the reinforcement learning engine. This closed-loop feedback mechanism facilitates the continuous refinement of anomaly detection parameters, ensuring that the system (100) evolves and improves autonomously over time, without necessitating manual reconfiguration.

In another embodiment of the present disclosure, the system (100) further comprises an output interface (160) configured to deliver real-time reports and alerts corresponding to verified anomalies. The output interface (160) may support multiple communication channels, including graphical dashboards, email notifications, SMS alerts, and API endpoints for integration with third-party systems. Reports generated by the output interface (160) may include detailed anomaly profiles, probabilistic confidence scores, validation outcomes, and suggested mitigation strategies.

In an aspect of the present disclosure, the method of operation of the present invention involves a sequence of steps beginning with the acquisition of structured and unstructured data from heterogeneous sources using the data gathering module (110). The data undergoes preprocessing to cleanse and normalize it, followed by feature extraction to derive analytical representations. Anomaly detection is performed using the Reinforced variational learning module (130), wherein dynamic optimization of detection parameters is achieved through reinforcement learning. Detected anomalies are probabilistically scored and subsequently validated against historical and contextual parameters. The outcomes of the verification process are fed back into the system (100) to iteratively refine performance. Finally, verified anomalies are reported and communicated via the output interface (160).

The present invention may be implemented as a non-transitory computer-readable medium storing instructions that, when executed by one or more processors, cause the system (100) to perform the steps described herein. The architecture is designed to be modular, allowing seamless integration with existing IT infrastructures and facilitating future upgrades and expansions.

In an exemplary embodiment of the present disclosure, the performance of the present system and a standard Autoencoder is evaluated on an anomaly detection dataset comprising 2,000 samples. The dataset contains both normal and anomalous instances, providing a comprehensive benchmark for model comparison as shown in the table below.

| Metric | Present system | Autoencoder |
|---|---|---|
| AUROC | 0.7684 | 0.6737 |
| AUPRC | 0.3725 | 0.2998 |
| F1 Score | 0.3864 | 0.2864 |
| Precision | 0.3542 | 0.2783 |
| Recall | 0.4250 | 0.2950 |
| False Positive Rate | 0.0861 | 0.0850 |
| Accuracy | 0.8650 | 0.8530 |

The results shown in the table demonstrate that the present system has higher AUROC, AUPRC, F1 Score, Precision, Recall, and Accuracy compared to the standard Autoencoder.

| Metric | Present system | Autoencoder |
|---|---|---|
| True Positives (TP) | 85 | 59 |
| False Positives (FP) | 155 | 153 |
| False Negatives (FN) | 115 | 141 |
| True Negatives (TN) | 1645 | 1647 |
| Total samples | 2000 | 2000 |

As illustrated in the table, the present system has more true positives (85 vs. 59) while maintaining a similar false positive rate. These findings validate the effectiveness of the proposed approach for robust anomaly detection. These results validate the effectiveness of the present system, particularly the benefits of incorporating multiple reasoning paths and verification mechanisms for anomaly detection tasks.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

While the invention has been described in connection with what is presently considered to be the most practical and various embodiments, it is to be understood that the invention is not to be limited to the disclosed embodiments, but on the contrary, is intended to cover various modifications and equivalent arrangements.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A system for cognitive, self-verifying anomaly detection through reinforced variational learning, comprising:
a data gathering module to acquire structured and unstructured data from a plurality of heterogeneous data sources;
a preprocessing module coupled to the data gathering module, to cleanse, normalize, and transform the acquired data into a format suitable for analysis;
a reinforced variational learning module coupled to the preprocessing module, the reinforced variational learning module comprising:
a feature extraction sub-module to extract relevant features and patterns from the preprocessed data;
an anomaly detection sub-module to identify potential anomalies by analyzing the extracted features and patterns using one or more anomaly detection parameters;
a reinforcement learning engine to optimize the anomaly detection parameters dynamically based on feedback derived from the accuracy and performance of detected anomalies; and
a variational inference model to assign probabilistic scores indicating the likelihood that the identified anomalies are true anomalies;
a verification module coupled to the reinforced variational learning module, to validate detected anomalies by cross-referencing with historical data and predefined contextual parameters;
a feedback module coupled to the verification module and the reinforced variational learning module, to update and refine the anomaly detection parameters based on the outcomes of the verification module; and
an output interface communicatively coupled to the verification module, the output interface being configured to generate and display real-time reports and alerts corresponding to verified anomalies.

2. The system as claimed in claim 1, wherein the data gathering module is further configured to perform real-time data acquisition from streaming sources and periodically batch data collection from static repositories.

3. The system as claimed in claim 1, wherein the preprocessing module comprises a data deduplication unit, a noise reduction unit, and a data transformation unit for handling missing values and outlier correction.

4. The system as claimed in claim 1, wherein the anomaly detection sub-module utilizes anomaly detection parameters selected from the group consisting of: statistical thresholds, clustering distance metrics, reconstruction errors, and temporal deviation scores.

5. The system as claimed in claim 1, wherein the reinforcement learning engine employs a reward function based on metrics selected from the group consisting of: detection accuracy, false positive rate, false negative rate, and anomaly severity impact.

6. The system as claimed in claim 1, wherein the reinforced variational learning module implements the variational inference model using a reinforcement learning variational autoencoder (RLVAE) configured to learn latent representations of normal and anomalous data distributions.

7. The system as claimed in claim 1, wherein the verification module further comprises a rule-based validation engine and a machine learning-based contextual evaluator to enhance the accuracy of anomaly validation.

8. A method for cognitive self-verifying anomaly identification, the method comprising the steps of:
acquiring structured and unstructured data from a plurality of heterogeneous data sources using a data gathering module;
preprocessing the acquired data by cleansing, normalizing, and transforming it into a format suitable for analysis;
extracting relevant features and patterns from the preprocessed data using a feature extraction sub-module;
identifying potential anomalies by analyzing the extracted features and patterns with one or more anomaly detection parameters using an anomaly detection sub-module;
optimizing the anomaly detection parameters dynamically based on feedback derived from the accuracy and performance of detected anomalies using a reinforcement learning engine;
assigning probabilistic scores indicating the likelihood that the identified anomalies are true anomalies using a variational inference model;
validating the detected anomalies by cross-referencing with historical data and predefined contextual parameters using a verification module;
updating and refining the anomaly detection parameters based on the outcomes of the verification step using a feedback module; and
generating and displaying real-time reports and alerts corresponding to verified anomalies via an output interface.

9. The method as claimed in claim 8, wherein the step of validating the detected anomalies comprises cross-referencing the anomalies with historical data and contextual parameters to confirm the accuracy of the anomaly detection, and wherein the method further comprises updating the anomaly detection parameters based on the validation outcome to enhance future anomaly identification performance.
